(19) United States
(12) Patent Application Publication
(10) Pub. No.: US 2006/0164443 A1
(43) Pub. Date: Jul. 27, 2006

(54) Modulating spatial light modulator with logically OR'ed values of bit planes

(76) Inventors: Wiatt E. Kettle, Corvallis, OR (US); Matthew J. Gelhaus, Albany, OR (US); Brett E. Dahlgren, Lebanon, OR (US); Karsten N. Wilson, Corvallis, OR (US); Kean Tong Lee, Singapore (SG)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/043,511

(22) Filed: Jan. 26, 2005

(51) Int. Cl. G09G 5/10

(52) U.S. Cl. 345/690

(57) ABSTRACT

For each bit plane of a plurality of bit planes of a pixel, a first spatial light modulator is modulated in accordance with a value of the bit plane. For each bit plane of at least one of the plurality of bit planes of the pixel, a second spatial light modulator is modulated in accordance with the value of the bit plane as logically OR'ed with values of corresponding bit planes of neighboring pixels to the pixel.

### BACKGROUND

Projection systems have become an increasingly popular way to display image data. One type of projection system uses spatial light modulators to modulate light in accordance with image data. Light is projected onto the spatial light modulators, and then is directed outwards for display. The analog or digital value of each pixel or sub-pixel of the image data may be used to control the pulse-width modulation of at least a portion of a given spatial light modulator. In particular, each bit of each pixel or sub-pixel of the image data may be used to control the pulse-width modulation of at least a portion of a spatial light modulator for a length of time corresponding to the significance of that bit in relation to the other bits of the pixel or sub-pixel in question.

To improve picture quality of projectors, two spatial light modulators or two groups of spatial light modulators may be placed in series. A portion of each modulator or each group of modulators modulates light based on the same pixel or sub-pixel of the image data at the same time. Light is thus projected onto the first modulator or the first group of modulators, then onto the second modulator or the second group of modulators, and finally is directed outwards for display. Such series or sequential projection systems improve contrast ratio. However, contouring artifacts can result if pulse width-modulated modulators are not nearly perfectly aligned with one another, which can be difficult to control in manufacture of the projectors.

### BRIEF DESCRIPTION OF THE DRAWINGS

The drawings referenced herein form a part of the specification. Features shown in the drawing are meant as illustrative of only some embodiments of the invention, and not of all embodiments of the invention.

FIG. 1 is a rudimentary diagram depicting how two spatial light modulators or two groups of spatial light modulators are configured in optical series with one another within a projection system, according to an embodiment of the invention.

FIG. 2 is a diagram depicting how the analog or digital values of some pixels or sub-pixels are used to control pulse width-modulated spatial light modulators to modulate light in accordance therewith, according to an embodiment of the invention.

FIG. 3 is a diagram depicting how a given bit or bit plane of a pixel or a sub-pixel can be dilated, according to an embodiment of the invention.

FIG. 4 is a diagram depicting how the analog or digital values of some pixels or sub-pixels are used to control pulse width-modulated spatial light modulators to modulate light in accordance therewith as dilated, according to an embodiment of the invention.

FIG. 5 is a diagram depicting how different pixels of image data have different numbers of neighboring pixels, depending on where they are located within the image data, according to an embodiment of the invention.

FIG. 6 is a flowchart of a method for projecting image data using two spatial light modulators, according to an embodiment of the invention.

FIG. 7 is a diagram of a representative projector or projection system, according to an embodiment of the invention.

### DETAILED DESCRIPTION OF THE DRAWINGS

In the following detailed description of exemplary embodiments of the invention, reference is made to the accompanying drawings that form a part thereof, and in which is shown by way of illustration specific exemplary embodiments in which the invention may be practiced. These embodiments are described in sufficient detail to enable those skilled in the art to practice the invention. Other embodiments may be utilized, and logical, mechanical, electrical, electro-optical, software/firmware and other changes may be made without departing from the spirit or scope of the present invention. The following detailed description is, therefore, not to be taken in a limiting sense, and the scope of the present invention is defined only by the appended claims.

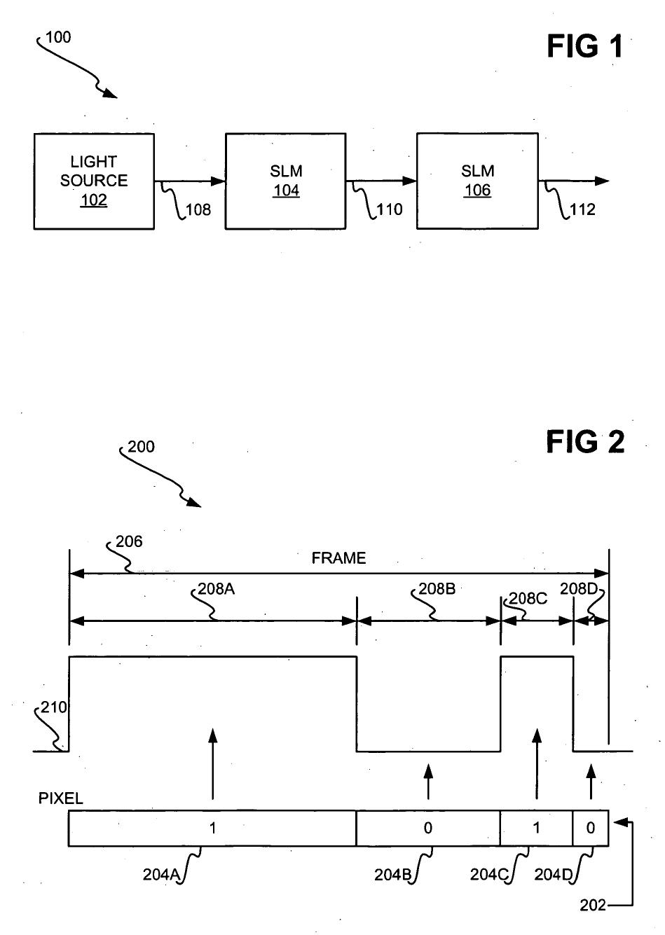

FIG. 1 shows a rudimentary scenario 100 of how two spatial light modulators 104 and 106 are situated in optical series with one another to project light, according to an embodiment of the invention. Light is output from a light source 102, as indicated by the arrow 108, and is incident upon a first spatial light modulator 104. The light is directed from the first spatial light modulator 104 to a second spatial light modulator 106, as indicated by the arrow 110. The light is finally directed from the second spatial light modulator 106, outward for display, as indicated by the arrow 112. The spatial light modulators 104 and 106 are located in optical series with one another. The spatial light modulator 104 is thus located before the modulator 106 in this series, and the spatial light modulator 106 is located after the modulator 104 in this series.

Each of the spatial light modulators 104 and 106 may in one embodiment be a group of spatial light modulators, and thus may each be considered a light-modulating mechanism. Together, the spatial light modulators 104 and 106 may be considered a modulation mechanism for a projector or a projection system. The spatial light modulators 104 and 106 modulate light in accordance with the analog or digital values of pixels or sub-pixels. As used herein, the terminology pixel is used synonymously with the terminology sub-pixel. Thus, whereas a pixel may encompass a red sub-pixel, a green sub-pixel, and a blue sub-pixel, for instance, the terminology pixel is used as shorthand for any or all of the sub-pixels of the pixel, such as any or all of the red, green, and blue sub-pixels of that pixel.

FIG. 2 shows a scenario 200 depicting how one of the spatial light modulators 104 and 106 modulates light in accordance with the analog or digital value of a pixel 202, according to an embodiment of the invention. As can be appreciated by those of ordinary skill within the art, typically a spatial light modulator modulates light in accordance with the analog or digital values of a portion if not all of the pixels of image data to be displayed. For descriptive clarity and simplicity, then, the scenario 200 depicts how a portion of one of the spatial light modulators 104 and 106 modulates light in accordance with a given pixel, such as a given sub-pixel of that pixel. That is, that a spatial light modulator is modulated in accordance with a given pixel encompasses just a portion of that modulator being modulated in accordance with a given pixel. The scenario 200 is described in particular relation to the spatial light modulators 104 and 106 being pulse width-modulated spatial light modulators.

The spatial light modulator in question modulates light based on an analog or digital value of the pixel 202 for a given time frame 206. The time frame 206 may encompass 1/30 of a second, 1/60 of a second, or another time period. The pixel 202 has a number of bits 204A, 204B, 204C, and 204D, collectively referred to as the bits 204 of the pixel 202. The bits 204 may also be referred to as the bit planes of the pixel 202. The pixel 202 is depicted in FIG. 2 as having four bits 204 for simplicity. However, in actuality, the pixel 202 may have eight, ten, twelve, or more of the bits 204.

The bits 204 include a most significant bit 204A, a least significant bit 204D, and bits 204B and 204C, where the bit 204B is more significant than the bit 204C and is less significant than the bit 204A, and the bit 204C is more significant than the bit 204D. The modulator is pulse width modulated, as indicated by the line 210, based on the weighted logical values of the bits 204 of the pixel 202 in accordance with the significance of the bits 204 of the pixel 202. The time frame 206 may be considered as having Σ^{j-1}ᵢ₌₀ 2ⁱ−2^{j}−1 parts, where j is the total number of bits 204 within the pixel 202. Each of the bits 204 is used to control modulation of the spatial light modulator for 2^{k} of those parts, where k is the number of the bit, k=0 denoting the least significant bit, and k=3 denoting the most significant bit.

For example, the most significant bit 204A of the pixel 202 has a logical value of one. Therefore, a portion 208A of the time frame 206 is pulse-width modulated high in accordance with the logical value of the bit 204A. The portion 208A of the time frame 206 extends for eight of the fifteen parts into which the time frame 206 can be considered as having been divided. The bit 204B of the pixel 202 has a logical value of zero. Therefore, a portion 208B of the time frame 206 is pulse-width modulated low in accordance with the logical value of the bit 204B, and extends for four of the fifteen parts into which the time frame 206 has been divided. The bit 204C of the pixel 202 has a logical value of one, such that a portion 208C of the time frame 206 is pulse-width modulated high in accordance with the logical value of the bit 204C, and extends for two of the fifteen parts into which the time frame 206 has been divided. Finally, the bit 204D of the pixel 202 has a logical value of zero, such that a portion 208D of the time frame 206 is pulse-width modulated low in accordance with the logical value of the bit 204D, extending for one of the fifteen parts into which the time frame 206 has been divided.

The scenario 200 of FIG. 2 is one example by which a given spatial light modulator can be modulated by the logical value of the bits of a pixel. In another embodiment, the spatial light modulator may be modulated first with the least significant bit of the pixel, and last with the most significant bit of the pixel. Alternatively, the high logical values and the low logical values of the bits of a pixel may be grouped, so that within a given time frame 206, there is at most a single transition from a high pulse to a low pulse, or vice-versa. Furthermore, one or more of the bit planes may be hybridized, or split.

Within the scenario 200 of FIG. 2, modulation of the spatial light modulator is based on the logical values of the bits, or bit planes, of a given pixel, and is not based on the logical values of the bits, or bit planes, of other pixels in addition to the given pixel. In other embodiments, however, one or more of the bits, or bit planes, of a given pixel may be dilated insofar as control of the spatial light modulator is concerned. That is, the logical values of bits, or bit planes, of other pixels, in addition to the bits, or bit planes, of a given pixel may be used when controlling the spatial light modulator with respect to the given pixel.

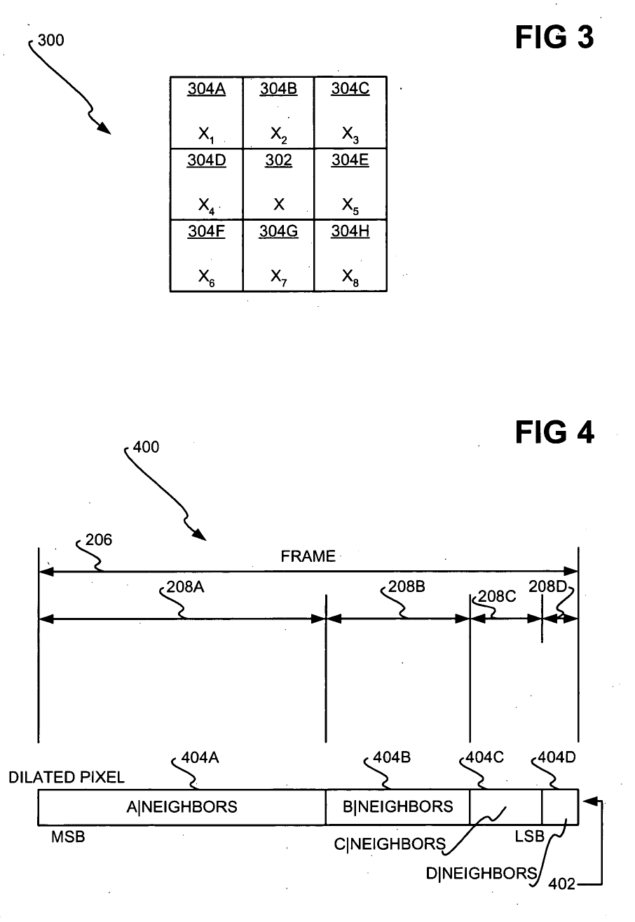

FIG. 3 shows a dilation matrix 300 for a given bit or bit plane of a pixel 302, according to an embodiment of the invention. The pixel 302 has neighboring pixels 304A, 304B, 304C, 304D, 304E, 304F, 304G, and 304H, collectively referred to as the neighboring pixels 304. The pixels 304 neighbor the pixel 302 in that each of the pixels 304 shares an edge or a corner with the pixel 302. The dilation matrix 300 can be used to dilate the pixel 302 when controlling a spatial light modulator with respect to the pixel 302.

Specifically, the logical value of a particular bit or bit plane of the pixel 302 can be logically OR'ed with the logical values of corresponding bits or bit planes of the neighboring pixels 304 when controlling a spatial light modulator with respect to that particular bit or bit plane of the pixel 302. Rather than using the logical value X for a specific bit or bit plane of the pixel 302, the logical value

$${\sum }_{i = 1}^{8} X \vert {X}_{i}$$

is used, where the logical value Xᵢ is the logical value of the corresponding bit or bit plane of the neighboring pixel i. In other words, the logical value X is replaced by the logical OR'ing of the logical value X of the bit of the pixel 302 with all of the logical values Xᵢ of the corresponding bits of the neighboring pixels 304. Thus, the logical value X is replaced by X|X₁|X₂|X₃|X₄|X₅|X₆|X₇|X₈ when controlling a spatial light modulator with respect to the particular bit or bit plane of the pixel 302.

FIG. 4 shows a scenario 400 depicting how one of the spatial light modulators 104 and 106 therefore can modulate light in accordance with the analog or digital value of a pixel as has been dilated, according to an embodiment of the invention. The scenario 400 is described in particular relation to the spatial light modulators 104 and 106 being pulse width-modulated spatial light modulators. The pixel has a most significant bit A, a least significant D, and bits B and C, where the bit B is less significant than the bit A but more significant than the bit C, and the bit C is more significant than the bit D. Rather than controlling the spatial light modulator in question based on the logical values of the bits A, B, C, and D, as has been described in relation to FIG. 2, the spatial light modulator is instead controlled by the logical values of the bits A, B, C, and D as dilated, or as logically OR'ed with the logical values of corresponding bits of neighboring pixels.

Therefore, a most significant bit 404A of the dilated pixel 402 for controlling the spatial light modulator during the portion 208A of the frame 206 is equal to the logical value of the most significant bit A of the pixel as logically OR'ed with the most significant bits of the pixels that neighbor the pixel in question. A least significant bit 404D of the dilated pixel 402 for controlling the spatial light modulator during the portion 208B of the frame 206 is equal to the logical value of the least significant bit D of the pixel as logically OR'ed with the least significant bits of the pixels that neighbor the pixel in question. Similarly, the bits 404B and 404C of the dilated pixel 402 for controlling the spatial light modulator during the portions 208C and 208D of the frame 206 is equal to the logical value of the bits B and C, respectively, of the pixel as logically OR'ed with corresponding bits of the pixels that neighbor the pixel.

The scenario 400 of FIG. 4 differs from the scenario 200 of FIG. 2 by using the logical bit values of a pixel as has been dilated based on the logical bit values of neighboring pixels to control modulation of a spatial light modulator, instead of using just the logical bit values of the pixel without consideration of the logical bit values of neighboring pixels. For example, in the scenario 200 of FIG. 2, the most significant bit 204A of the pixel 202 is used to control the spatial light modulator during the portion 208A of the frame 206, where the logical value of the bit 204A of the pixel 202 does not depend on any pixels neighboring the pixel 202. However, in the scenario 400 of FIG. 4, the most significant bit 404A of the dilated pixel 402 is used to control the spatial light modulator during the portion 208A of the frame 206. The logical value of the bit 404A of the dilated pixel 402, by comparison, depends on the logical value of the most significant bit A of the pixel being dilated, as logically OR'ed with the logical values of the most significant bits of the pixels neighboring this pixel.

In a different embodiment, not all of the bits or bit planes of a pixel are dilated as has been described in controlling a spatial light modulator. For example, only the most significant bit A of the pixel being dilated may be logically OR'ed with the logical values of the most significant bits of the neighboring pixels to result in the most significant bit 404A of the dilated pixel 402. The other bits 402B, 402C, and 402D may be equal to the logical values of the bits B, C, and D of the pixel being dilated, without logically OR'ing their logical values with the logical values of corresponding bits of neighboring pixels.

In other words, in one embodiment, at least one of the bits of a pixel are dilated in accordance with the scenario 400 of FIG. 4, and the other bits of the pixel are not dilated. The bits of the pixel that are not dilated may, however, be processed in manners or techniques other than has been described in accordance with the scenario 200 of FIG. 2. For example, such bits may be hybridized, as has been already noted.

Furthermore, dilation of a bit or a bit plane of a given pixel may be accomplished in a manner other than as has been described herein. For instance, neighboring pixels may be defined differently than as has been described herein, and/or dilation may be accomplished in a manner other than by logical OR'ing. As another example, multiple rings of pixels may be defined as the neighboring pixels for pixel dilation purposes. For instance, for a given pixel, the immediately surrounding pixels, and the pixels immediately surrounding those pixels, may be the neighboring pixels. Furthermore, not all of the neighboring pixels need to be included within the dilation matrix defining which pixels are logically OR'ed with a given pixel. For example, the neighboring pixels may be defined as including, for a given pixel, the two pixels horizontally closest to the pixel to either side, but just one pixel that is vertically closest to the pixel to either side. As another example, only pixels located horizontally or vertically to a given pixel may be defined as the neighboring pixels to that pixel, and not pixels that are located diagonally to the pixel in question. More generally, the dilation of a bit or a bit plane of a given pixel can result from using any function of the logical value of the bit or bit plane and the logical values of any combination of the corresponding bits or bit planes of neighboring pixels.

In one embodiment, the SLM 104 of FIG. 1 is controlled in accordance with the scenario 200 of FIG. 2, and the spatial light modulator 106 of FIG. 1 is controlled in accordance with the scenario 400 of FIG. 4. That is, the spatial light modulator 104 is controlled in accordance with non-dilated pixels, and the spatial light modulator 106 is controlled in accordance with dilated pixels. In another embodiment, the spatial light modulator 104 is controlled in accordance with the scenario 400, and the spatial light modulator 106 is controlled in accordance with the scenario 200. That is, the spatial light modulator 104 is controlled in accordance with dilated pixels, and the spatial light modulator 106 is controlled in accordance with non-dilated pixels.

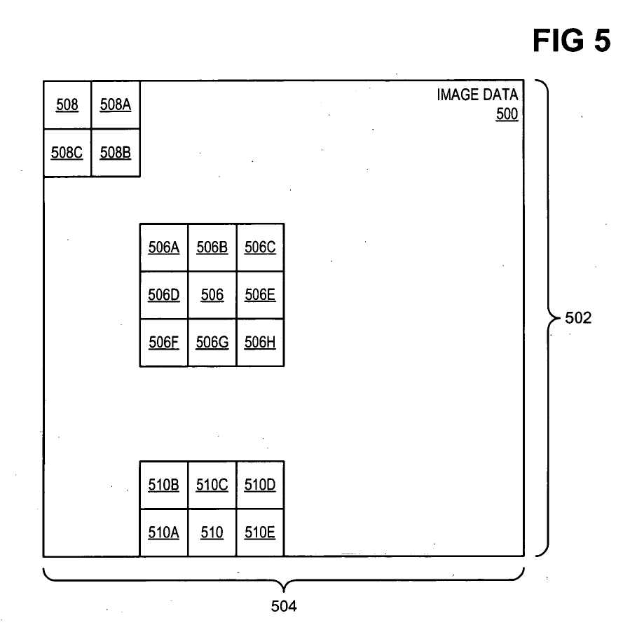

FIG. 5 shows how the pixels of image data 500 organized into rows 502 and columns 504 have different numbers of neighboring pixels depending on their location, according to an embodiment of the invention. Three different types of pixels are exemplarily depicted in FIG. 5: an interior pixel 506, a corner pixel 508, and an edge pixel 510. The pixels 506, 508, and 510 and their neighboring pixels are depicted in exaggerated size in FIG. 5, and in actually there may be 800×600 or more (or less) of such pixels within the image data 500.

The interior pixel 506 is a pixel located at least one pixel in from all edges and all corners of the image data 500, and has eight neighboring pixels 506A, 506B, 506C, 506D, 506E, 506F, 506G, and 506H. The corner pixel 508 is a pixel located at a corner of the image data 500, such as the upper-left hand corner in the specific example of FIG. 5. The corner pixel 508 has three neighboring pixels 508A, 508B, and 508C. The edge pixel 510 is a pixel located at a single edge of the image data 500, such as the bottom edge in the specific example of FIG. 5, but not at a corner of the image data 500. The edge pixel 510 has five neighboring pixels 510A, 510B, 510C, 510D, and 510E.

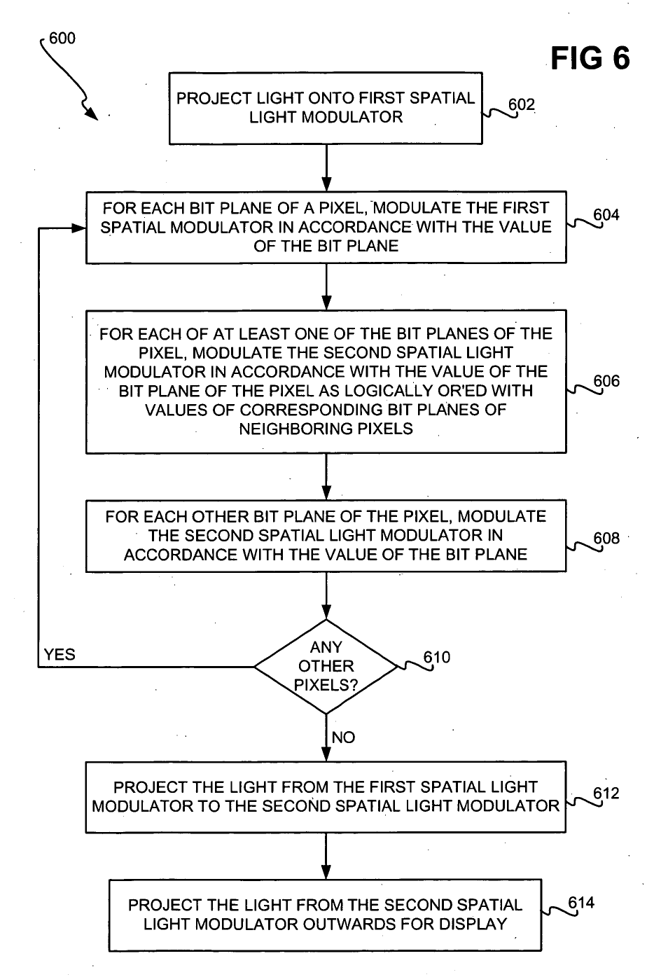

FIG. 6 shows a method 600 for projecting the pixels of image data using two spatial light modulators, according to an embodiment of the invention. The method 600 is repeated for each frame of the image data. First, light is projected by a light source onto the first spatial light modulator (602). For each bit plane of a given pixel or sub-pixel, the first spatial light modulator, such as a portion thereof, is pulse-width modulated, or otherwise modulated, in accordance with the logical value of that bit plane (604), as has been described in relation to FIG. 2.

Next, for each of at least one of the bit planes of the pixel or sub-pixel, the second spatial light modulator is pulse-width or otherwise modulated in accordance with the logical value of the bit plane in question as logically OR'ed with logical values of corresponding bit planes of neighboring pixels (606), as has been described in relation to FIG. 4. Alternatively, these bit planes of the pixel or sub-pixel are otherwise dilated, instead of by logical OR'ing. For each other bit plane of the pixel or sub-pixel, if any, the second spatial light modulator is modulated in accordance with just the logical value of the bit plane, or by another approach other than dilation (608). That is, the second spatial light modulator may be modulated in accordance with some bit planes of the pixel or sub-pixel in which dilation occurs, and in accordance with other bit planes in which dilation does not occur. Thus, for the bit planes in which dilation does not occur, just the logical value of each such bit plane may be used to control pulse-width modulation, or other approaches and techniques, such as bit plane hybridization, may be employed.

In a different embodiment, the first spatial light modulator and the second spatial light modulator may be switched, such that the second spatial light modulator is modulated in accordance just with the logical values of the bit planes of the pixel or sub-pixel, and the first spatial light modulator is modulated in accordance with the logical values of one or more of the bit planes being dilated. The dilation of pixels compensates for visual artifacts that can occur when using two spatial light modulators in optical series with one another. In particular, the dilation of pixels at least substantially reduces the darkened contouring artifacts that may otherwise occur when using two spatial light modulators in optical series with one another.

If there are any other pixels of the current frame of the image data being projected (610), then the method 600 repeats at 604 with a new pixel. Otherwise, the light projected onto the first spatial light modulator is directed or projected from the first spatial light modulator to the second spatial light modulator (612). The light is then directed or projected from the second spatial light modulator outwards for display (614).

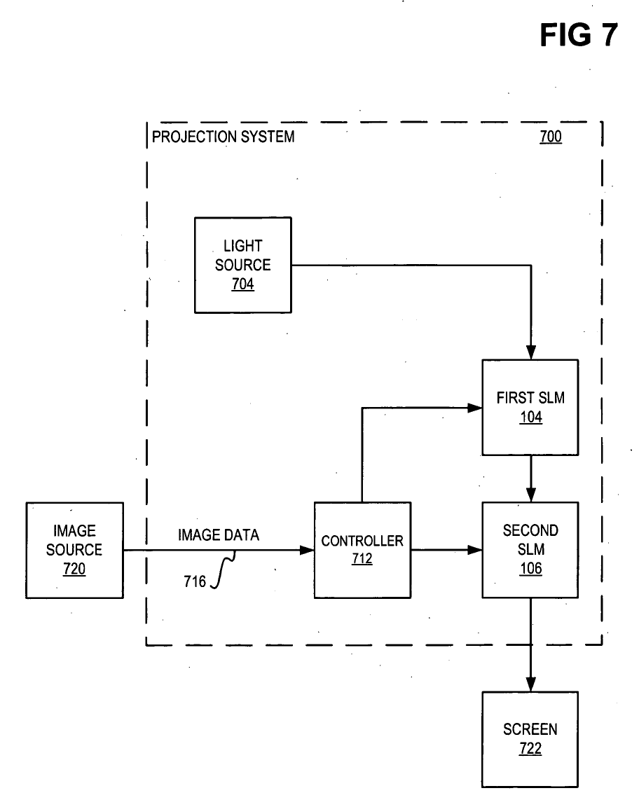

FIG. 7 shows a representative projection system 700 according to an embodiment of the invention. The system 700 may be implemented as a projector. As can be appreciated by those of ordinary skill within the art, the system 700 includes components specific to a particular embodiment of the invention, but may include other components in addition to or in lieu of the components depicted in FIG. 7. The projection system 700 includes a light source 704, the spatial light modulators 104 and 106 that have been described, a controller 712 operatively or otherwise coupled to an image source 720 to receive image data 716, as well as a screen 722.

The light source 704 outputs light. The light source 704 may be an ultra high pressure (UHP) mercury vapor arc lamp, or another type of light source. For instance, the light source 704 may be other types of light bulbs, as well as other types of light sources such as light-emitting diodes (LED's), and so on. The light output by the light source 704 is for ultimate modulation by the spatial light modulators 104 and 106. The controller 712 controls the spatial light modulators 104 and 106 in accordance with the image data 716 received from the image source 720. The controller 712 may be implemented in hardware, software, or a combination of hardware and software. The image source 720 may be a computing device, such as a computer, or another type of electronic and/or video device.

The light output by the light source 704 is thus projected on the spatial light modulator 104, from the spatial light modulator 104 onto the spatial light modulator 106, and outwards from the projection system 700, where it is displayed on the screen 722, or another physical object, such as a wall, and so on. The screen 722 may be a front screen or a rear screen, such that the projection system 700 may be a front-projection system or a rear-projection system, as can be appreciated by those of ordinary skill within the art. The user of the projection system 700, and other individuals able to see the screen 722, are then able to view the image data 716.

It is noted that, although specific embodiments have been illustrated and described herein, it will be appreciated by those of ordinary skill in the art that any arrangement is calculated to achieve the same purpose may be substituted for the specific embodiments shown. This application is intended to cover any adaptations or variations of the present invention. Therefore, it is manifestly intended that this invention be limited only by the claims and equivalents thereof.

We claim:

1. A method comprising:
for each bit plane of a plurality of bit planes of a pixel, modulating a first spatial light modulator in accordance with a value of the bit plane; and,
for each bit plane of at least one of the plurality of bit planes of the pixel, modulating a second spatial light modulator in accordance with the value of the bit plane as logically OR'ed with values of corresponding bit planes of neighboring pixels to the pixel.

2. The method of claim 1, further comprising, for each bit plane of the plurality of bit planes of the pixel other than the at least one of the plurality of bit planes of the pixel, modulating the second spatial light modulator in accordance with the value of the bit plane.

3. The method of claim 2, further comprising, for each bit plane of the plurality of bit planes of the pixel other than the at least one of the plurality of bit planes of the pixel, modulating the second spatial light modulator in a manner other than by logically OR'ing the value of the bit plane with values of corresponding bit planes of neighboring pixels to the pixel.

4. The method of claim 1, further comprising repeating the method for each pixel of a plurality of other pixels.

5. The method of claim 1, further comprising projecting light from the first spatial light modulator as modulated, to the second spatial light modulator as modulated, and outwards for projection of the pixel for display.

6. The method of claim 1, further comprising projecting light from the second spatial light as modulated, to the first spatial light modulator as modulated, and outward for projection of the pixel for display.

7. The method of claim 1, wherein the second spatial light modulator is located in optical series with and before the first spatial light modulator.

8. The method of claim 1, wherein the second spatial light modulator is located in optical series with and after the first spatial light modulator.

9. The method'of claim 1, wherein the second spatial light modulator is modulated in accordance with the value of the bit plane as logically OR'ed with values of corresponding bit planes of neighboring pixels to the pixel for each bit plane of all of the plurality of bit planes of the pixel.

10. The method of claim 1, wherein the neighboring pixels to the pixel comprise:
a first pixel immediately to the left of the pixel, where the pixel is not at a left-most edge of an image;
a second pixel to the left and upward of the pixel, where the pixel is not at the left-most edge of the image or is not at an upper-most edge of the image;
a third pixel to the left and downward of the pixel, where the pixel is not at the left-most edge of the image or is not at a bottom-most edge of the image;
a fourth pixel immediately upward of the pixel, where the pixel is not at the upper-most edge of the image;
a fifth pixel immediately to the right of the pixel, where the pixel is not at a right-most edge of the image;
a sixth pixel to the right and upward of the pixel, where the pixel is not at the upper-most edge of the image or is not at the right-most edge of the image;
a seventh pixel immediately downward of the pixel, where the pixel is not at the bottom-most edge of the image; and,
an eighth pixel to the right and downward of the pixel, where the pixel is not at the bottom-most edge of the image or is not at the right most edge of the image.

11. The method of claim 1, wherein at least one of the first spatial light modulator and the second spatial light modulator comprises a plurality of spatial light modulators.

12. The method of claim 1, wherein modulating the first spatial light modulator comprises pulse-width modulating the first spatial light modulator and modulating the second spatial light modulator comprises pulse-width modulating the second spatial light modulator.

13. A method comprising:
for each bit plane of a plurality of bit planes of a pixel, modulating a first spatial light modulator in accordance with a value of the bit plane; and,
for each bit plane of at least one of the plurality of bit planes of the pixel, modulating a second spatial light modulator in accordance with the value of the bit plane as dilated based on values of corresponding bit planes of neighboring pixels to the pixel.

14. The method of claim 13, further comprising, for each bit plane of the plurality of bit planes of the pixel other than the at least one of the plurality of bit planes of the pixel, modulating the second spatial light modulator in accordance with the value of the bit plane.

15. The method of claim 13, further comprising repeating the method for each pixel of a plurality of other pixels.

16. The method of claim 13, wherein the second spatial light modulator is modulated in accordance with the value of the bit plane as dilated based on values of corresponding bit planes of neighboring pixels to the pixel for each bit plane of all of the plurality of bit planes of the pixel.

17. A modulation mechanism for a projection system comprising:
a first light-modulating mechanism to modulate light in accordance with a value of each bit plane of a plurality of bit planes of each pixel of a plurality of pixels of an image; and,
a second light-modulating mechanism located in optical series with the first light-modulating mechanism and to modulate light in accordance with the value of each bit plane of at least one of the plurality of bit planes of each pixel of the plurality of pixels of the image as logically OR'ed with values of corresponding bit planes of neighboring pixels to the pixel.

18. The modulation mechanism of claim 17, wherein the second light-modulating mechanism is further to modulate light in accordance with the value of each bit plane of the plurality of bit planes other than the at least one of the plurality of bit planes of each pixel of the plurality of pixels of the image.

19. The modulation mechanism of claim 17, wherein the second light-modulating mechanism is to modulate light in accordance with the value of each bit plane of all of the plurality of bit planes of each pixel of the plurality of pixels of the image as logically OR'ed with values of corresponding bit planes of neighboring pixels to the pixel.

20. The modulation mechanism of claim 17, wherein the first light-modulating mechanism is located before the second light-modulating mechanism.

21. The modulation mechanism of claim 17, wherein the first light-modulating mechanism is located after the second light-modulating mechanism.

22. The modulation mechanism of claim 17, wherein each of the first and the second light-modulating mechanisms comprises one or more spatial light modulators.

23. A modulation mechanism for a projection system comprising:
first means for modulating light in accordance with a value of each bit plane of a plurality of bit planes of each pixel of a plurality of pixels of an image; and,
second means for modulating light in accordance with the value of each bit plane of at least one of the plurality of bit planes of each pixel of the plurality of pixels of the image as dilated based on values of corresponding bit planes of neighboring pixels to the pixel.

24. The modulation mechanism of claim 23, wherein the second means is for modulating light in accordance with the value of each bit plane of at least one of the plurality of bit planes of each pixel of the image as dilated based on values of corresponding bit planes of neighboring pixels to the pixel by modulating light in accordance with the value of each bit plane of at least one of the plurality of bit planes of each pixel as logically OR'ed with the values of corresponding bit planes of neighboring pixels to the pixel.

25. A projection system comprising:
a light source to output light;
a first light-modulating mechanism to modulate the light output by the light source; and,
a second light-modulating mechanism located in optical series with the first light-modulating mechanism to modulate the light as modulated by the first light-modulating mechanism,
wherein one of the first and the second light-modulating mechanisms is to modulate light in accordance with a value of each bit plane of a plurality of bit planes of each pixel of a plurality of pixels of the image, and
wherein another of the first and the second light-modulating mechanisms is to modulate light in accordance with the value of each bit plane of at least one of the plurality of bit planes of each pixel of the plurality of pixels of the image as logically OR'ed with values of corresponding bit planes of neighboring pixels to the pixel.

26. The projection system of claim 25, wherein the other of the first and the second light-modulating mechanisms is further to modulate light in accordance with the value of each bit plane of the plurality of bit planes other than the at least one of the plurality of bit planes of each pixel of the plurality of pixels of the image.

27. The projection system of claim 25, wherein the other of the first and the second light-modulating mechanisms is to modulate light in accordance with the value of each bit plane of all of the plurality of bit planes of each pixel of the plurality of pixels of the image as logically OR'ed with values of corresponding bit planes of neighboring pixels to the pixel.

28. The projection system of claim 25, wherein each of the first and the second light-modulating mechanisms comprises one or more spatial light modulators.

29. The projection system of claim 25, further comprising a controller to control the first and the second light-modulating mechanisms in accordance with image data received by the controller.

30. A projection system comprising:
first means for outputting light;
second means for modulating the light output by the first means; and,
third means for modulating the light output by the second means,
wherein one of the second and third means is for modulating light in accordance with a value of each bit plane of a plurality of bit planes of each pixel of a plurality of pixels of the image, and
wherein another of the second and third means is for modulating light in accordance with the value of each bit plane of at least one of the plurality of bit planes of each pixel of the plurality of pixels of the image as dilated based on values of corresponding bit planes of neighboring pixels to the pixel.
